(19) United States
(12) Patent Application Publication
(10) Pub. No.: US 2006/0294564 A1
(43) Pub. Date: Dec. 28, 2006

(54) Sportcare set-top-box monitoring system

(75) Inventor: Fabien Marcel Jacques Guillorit, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/572,836

(22) PCT Filed: Sep. 21, 2004
(86) PCT No.: PCT/IB04/51814

§ 371 Date: Mar. 21, 2006

Related U.S. Application Data
(60) Provisional application No. 60/504,999, filed on Sep. 22, 2003.

(51) Int. Cl. H04N 7/173

(52) U.S. Cl. 725/108; 725/105; 725/100; 725/131

(57) ABSTRACT

A method for sportcare monitoring of a person is provided. The method including: operatively connecting a set-top-box (102) to at least one of a television display (104), a speaker (106), a first network (110), a remote station (124), and one or more wireless sensors (108); measuring one or more vital signs of the person with the one or more wireless sensors (108); wirelessly transmitting the one or more vital signs from the one or more wireless sensors (108) to the set-top-box (102); operatively connecting the remote station (124) to the set-top-box (102) through the first network (110); and transmitting the one or more vital signs from the set-top-box (102) to the remote station (124) via the first network (110).

The present invention relates generally to sportcare monitoring, and more particularly, to a personal system for monitoring sportcare through a set-top-box. Some people, such as a novice require supervision while exercising.

Typically, a sportcare professional, such as a personal trainer, monitors the person's progress in a gym or health club and offer suggestions, or advice for improvement.

However, such monitoring by a sportcare professional is very expensive. Furthermore, in some situations, particularly for the elderly, medical supervision is necessary while exercising.

There are systems known in the art that utilize a computer, such as a personal computer for monitoring the sportcare of an exercising person. However, such systems are not very useful because the computer is not always on, is not always located in a convenient place in the person's home, and requires a relatively complicated input through various input devices such as a keyboard or mouse.

Therefore it is an object of the present invention to provide a sportcare monitoring system that overcomes the disadvantages associated with the prior art sportcare monitoring systems.

Accordingly, a system for sportcare monitoring of a person is provided. The system comprising: a set-top-box operatively connected to at least one of a television display and speaker, the set-top-box being further operatively connected to a first network;

one or more wireless sensors for measuring one or more vital signs of the person and transmitting the same to the set-top-box, the one or more wireless sensors being wirelessly connected to the set-top-box. The first network can be the Internet. The system can further comprise communication means for operatively connecting a remote station to the set-top-box through the first network, wherein the one or more vital signs are transmitted from the set-top-box to the remote station via the first network. The remote station can be a location of a health club. The system can further comprise at least one sports equipment operatively connected to the set-top-box via the remote station for transmitting performance characteristics from the at least one sports equipment to the set-top-box. The set-top-box can further have a memory for storing the transmitted performance characteristics. The communication means can further transmit the performance characteristics to the remote station through the first network. The system can further comprise a first video camera operatively connected to the set-top-box for transmitting a video signal of the person to the remote station. The system can also further comprise a second video camera operatively connected to the remote station for transmitting a video signal of one or more individuals at the remote station to the set-top-box for display on the television display.

The set-top-box can have means for contacting a medical professional through a second network. The second network can be a telephone network.

Also provided is a method for sportcare monitoring of a person. The method comprising: operatively connecting a set-top-box to at least one of a television display, a speaker, a first network, a remote station, and one or more wireless sensors; measuring one or more vital signs of the person with the one or more wireless sensors; wirelessly transmitting the one or more vital signs from the one or more wireless sensors to the set-top-box; operatively connecting the remote station to the set-top-box through the first network; and transmitting the one or more vital signs from the set-top-box to the remote station via the first network.

The method can further comprise: operatively connecting at least one sports equipment to the set-top-box via the remote station; and transmitting performance characteristics from the at least one sports equipment to the set-top-box. In which case the method can further comprise storing the transmitted performance characteristics in a memory operatively connected to the set-top-box. The method can also further comprise transmitting the performance characteristics to the remote station through the first network.

The method can further comprise contacting a medical professional through a second network from the set-top-box.

The method can further comprise transmitting a video signal of the person to the remote station from a first video camera operatively connected to the set-top-box. In which case, the method can further comprise transmitting a video signal of one or more individuals at the remote station from a second video camera operatively connected to the remote station to the set-top-box for display on the television display.

The method can further comprise coaching the person from the remote station on at least one of the television display and speaker based on the transmitted at least one vital signs.

Where the set-top-box is further connected to a sports equipment, the method can further comprise coaching the person from the remote station on at least one of the television display and speaker based on the transmitted performance characteristics.

The method can further comprise displaying at least one of a performance of another exercising person or a performance characteristic of the another person on the television display such that the person can compete with the performance of the another person.

The method can further comprise displaying a performance characteristic of the person on the television display.

These and other features, aspects, and advantages of the apparatus and methods of the present invention will become better understood with regard to the following description, appended claims, and accompanying drawings where:

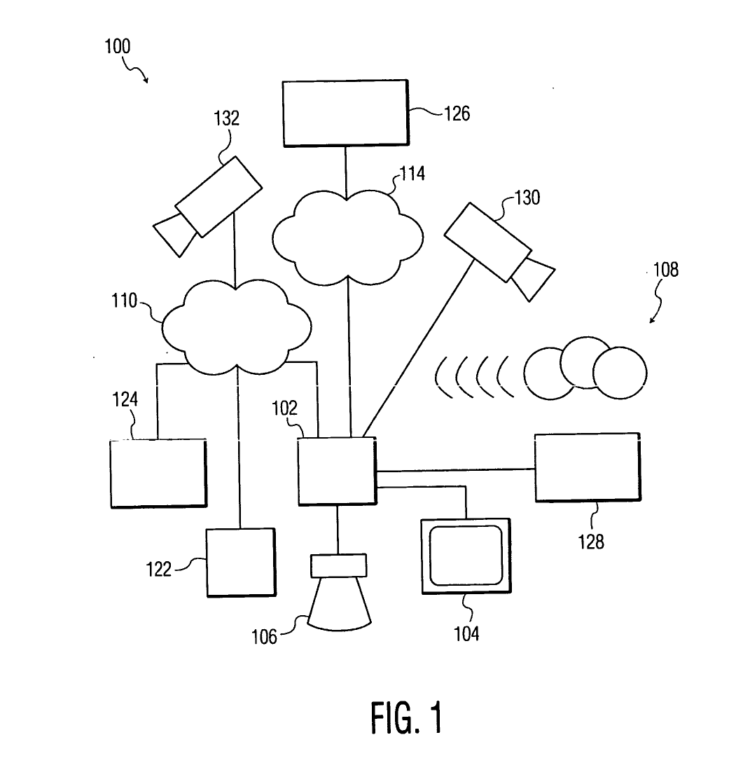

FIG. 1 illustrates a schematic illustration of an embodiment of a system for sportcare monitoring.

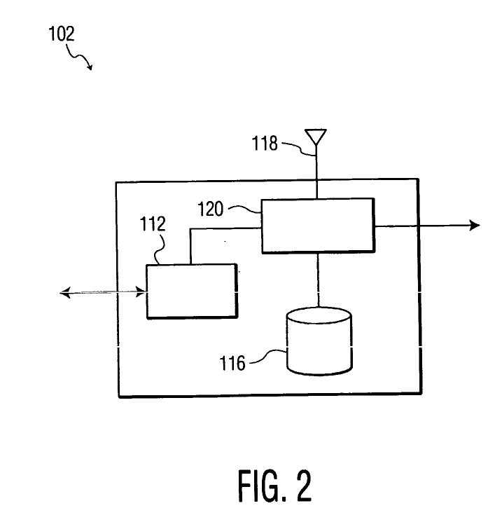

FIG. 2 illustrates a schematic illustration of a set-top-box for use with the system of FIG. 1.

Referring no to FIG. 1, there is shown a system for sportcare monitoring of a person, the system being generally referred to by reference numeral 100. The system 100 includes a set-tip-box 102 operatively connected to at least one of a television display 104 and a speaker 106. The system 100 preferably includes both the television display 104 and speaker(s) 106. Furthermore, the speaker(s) 106 can be integral with the television display 104 or separate therefrom, such as a surround sound/home theater system. The set-top-box 102, besides the functions described below can also be used for other functions associated with a television, such as a cable tuner or personal video recorder (PVR).

The system also includes one or more wireless sensors 108 for measuring vital signs of the person and wirelessly transmitting the same to the set-top-box 102. The one or more wireless sensors are wirelessly connected to the set-top-box 102. The one or more vital signs can be pulse, blood pressure, and the like. The wireless sensors 108 can communicate with the set-top-box 102 through any wireless medium, such as RF or infrared, and by any wireless protocol, such as Bluetooth, RFID, or Zigbee. The wireless sensors 108 can be lightweight and wearable by the person or heavy standalone equipment.

Referring now also to FIG. 2, the set-top-box 12 is illustrated therein in more detail. The set-top-box 104 is further operatively connected to a network, such as the Internet 110 through a modem 112. However, other remote networks are also possible, such as plain old telephony (POTS) 114, cellular, and satellite. Although a single modem 112 is shown in FIG. 2, those skilled in the art will appreciate that more than one modem may be used, each of which is dedicated to accessing a different network. For example, a cable modem may be used to access the Internet 110 and a dial-up modem may be used to access the telephone network 114. The Internet 110 may be used to access a data host 122 or a remote station 124, such as a healthcare professional, including a physical trainer, physical therapist, and the like. The telephone network 114 may also be used to access medical professionals, such as a doctor or nurse and may further be used to contact emergency services 126, such as a paramedic or ambulance service.

The set-top-box 102 also includes a storage device 116, such as a hard drive for storing program instructions for carrying out the methods of the present invention as well as other functions of the set-top-box 102. The storage device 116 can also be used to store video content and/or a user profile. Although the storage device 116 is shown as a single device, those skilled in the art will appreciate that it can be multiple storage devices, each dedicated to storing different types of data. The set-top-box 102 further includes a transmitter/receiver, shown schematically by antenna 118. The antenna 118 receives the wireless signals from the wireless sensors 108 which are processed, formatted, and/or transformed, if necessary, into a useful signal by a processor 120. The processor 120 also controls the modem 112, storage device 116, television display 104, and speaker 106 as is known in the art. The antenna 118 may be dedicated for use with the wireless sensors 108 or may be used in combination with other functions of the set-top-box 102, such as to receive wireless signals from a remote control (not shown) for use with the set-top-box 102. The remote control can be used to control the set-top-box 102 and may also be used to input information into the set-top-box 102 through an appropriate user interface as is known in the art.

Referring back to FIG. 1, the system 100 can further include sports equipment 128, such as a bicycle, stepping machine, rowing machine, or treadmill. The sports equipment 128 can be operatively connected (wired or wirelessly) to the set-top-box 102 for transmitting performance characteristics from the sports equipment 128 to the set-top-box 102. The performance characteristics can be any characteristic of the sports equipment that is an indicator of the performance of the person on the equipment. Where the sports equipment 128 is a bicycle, the performance characteristics may be the RPM of the pedals, the change in RPM per unit time, the duration of any particular period of activity, and the like. The performance characteristics can be stored at the memory 116 in the set-top-box 102 and/or transmitted to the remote station 124 via the network 110.

The system 100 may also be supplied with one or more video cameras 130 positioned at the location of the set-top-box 102 and operatively connected to the processor 120. The camera 130 is useful in capturing image or video of the person engaging in the physical activity and being monitored. The camera 130 may be supplied in more than one room of the person's home and may have pan-tilt-zoom capabilities in order to follow the person as he/she moves about the room to other exercises or on other sports equipment 128. The camera 130 may be under the control of a recognition system that can recognize and track the person and control the pan-tilt-zoom motors of the camera accordingly to maintain the person in the field of view of the camera 130. Such recognition systems are well known in the art. The system 100 may also have one or more cameras 132 at the remote station for capturing image or video of an individual, such as a personal trainer, at the remote station. The camera 132 at the remote station 124 may have the pan-tilt-zoom and recognition capabilities as previously described above with regard to camera 130.

A method for sportcare monitoring of a person will now be described with reference to FIGS. 1 and 2. As discussed above, the set-top-box 102 is operatively connected to a network, such as the Internet 110, and a remote station 124, such as a sportcare professional, via the modem 112. The set-top-box 102 is also operatively connected to at least one of, and preferably both of, the television display 104 and speaker 106 via the processor 120. The set-top-box 102 is further wirelessly connected to the sensors 108 via the antenna 118 and processor 120. The sensor(s) 108 detect at least one vital sign of the person and transmits a signal corresponding to the same to the set-top-box 102. The detected vital sign(s) are transmitted from the set-top-box 102 to the remote station 124 via the network 110 where they can be accessed by individuals at the remote station 124, such as a physical trainer or physical therapist. The one or more vital signs can be accessed in real-time, thus, permitting quick and timely decisions, suggestions, advice, etc. to be made in the best interests of the person being monitored. The sportcare professional would typically access the vital signs information on a display screen. The display screen is preferably part of a computer (not shown) that is operatively connected to the network 110. A history of the person's vital signs can be stored at the storage device 116 and accessed (e.g., printed) by a sportcare professional to determine the person's progress or to alert a medical professional if there is an abnormality in the vital signs. The sportcare professional at the remote station 124 can instruct the set-top-box 102 to contact a medical professional, such as emergency services 126, through another network, such as through the telephone network 114 if there is an abnormality in the vital signs or a dangerous situation is detected while video conferencing with the person (as discussed below). Thus, if the sportcare professional is concerned that a dangerous situation is imminent, he or she may instruct the set-top-box 102 to contact the police, a paramedic, or an ambulance. The contact information for the emergency services can be previously stored in the storage device 116 through an appropriate user interface. The person can also bring the history of their vital signs (while exercising) with them when they visit their doctor or health club.

The system 100 may also be used to provide a videoconference between an individual at the remote station (e.g., a physical therapist or trainer) and the person being monitored using the cameras 130, 132. Therefore, a video signal of the person from camera 130 can be transmitted from the set-top-box 102 to the remote station via the network 110 and displayed at a display device (not shown) at the remote station 124. Similarly, a video signal of the sportcare professional from camera 132 can be transmitted from the remote station 110 to the set-top-box 102 and displayed on the television display 104. In this manner, the sportcare professional and the person being monitored can conduct a videoconference and exchange comments, suggestions, advice, and/or questions.

The set-top-box 102 can be provided with means for generating, on the television display 104 and/or on the speakers 106, an artificial coach to provide advice and encourage the person training. The detected vital signs can also be displayed on the television screen 104 along with the artificial coach. The set-top-box 102 can also generate performance curves based on the performance characteristics and display the same on the television display 104.

The person can also be coached directly from a sportcare professional from the remote station 124 and his or her likeness displayed on the television display 104 and/or his or her voice reproduced on the speaker 106. The coaching, whether by the artificial coach or sportcare professional can be based on the detected vital signs and/or performance characteristics which can also be displayed on the television display 104.

The set-top-box 102 can also display a performance of another exercising person on the television display 104 (the other person would have a system 100 similar to the system of the person) so that the person can compete with the performance of the other person. Instead of or in addition to the display of another person exercising, the set-top-box 102 can display a performance characteristic of the other person on the television display 104 and the person can compete directly with the performance characteristics of the other person, possibly by also displaying the performance characteristics of the person on the same television display 104. The set-top-box can display a previous performance characteristic of the person on the television display so the person can try to improve on his or her own past performance.

Those skilled in the art will appreciate that the system 100 of the present invention offers certain advantages over the computer-based sportcare monitoring systems known in the art. Some of those advantages include:

(a) The set-top-box 102 can remain on standby and can “wake-up” the television display 104 or speakers 106 if the same are off; (b) Instructions and data can be input into the set-top-box 102 relatively easy, such as through a remote control and an appropriate user interface;

(c) If the television display 104 is off, the system 100 can still operate through the speakers 106; and

(d) The television display is often located in a more convenient location for exercising than is a computer.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A system (100) for sportcare monitoring of a person, the system comprising:
a set-top-box (102) operatively connected to at least one of a television display (104) and speaker (106), the set-top-box (102) being further operatively connected to a first network (110);
one or more wireless sensors (108) for measuring one or more vital signs of the person and transmitting the same to the set-top-box (102), the one or more wireless sensors (108) being wirelessly connected to the set-top-box (102).

2. The system of claim 1, further comprising communication means (112) for operatively connecting a remote station (124) to the set-top-box (102) through the first network (110), wherein the one or more vital signs are transmitted from the set-top-box (102) to the remote station (124) via the first network (110).

3. The system of claim 1, wherein the first network is the Internet (110).

4. The system of claim 2, wherein the remote station is a location of a health club (124).

5. The system of claim 2, further comprising at least one sports equipment (128) operatively connected to the set-top-box (102) via the remote station (124) for transmitting performance characteristics from the at least one sports equipment (128) to the set-top-box (102).

6. The system of claim 5, wherein the set-top-box (102) further having a memory (116) for storing the transmitted performance characteristics.

7. The system of claim 5, wherein the communication means (112) further transmits the performance characteristics to the remote station (124) through the first network (110).

8. The system of claim 1, wherein the set-top-box (102) having means (112) for contacting a medical professional through a second network (114).

9. The system of claim 8, wherein the second network is a telephone network (114).

10. The system of claim 2, further comprising a first video camera (130) operatively connected to the set-top-box (102) for transmitting a video signal of the person to the remote station (124).

11. The system of claim 10, further comprising a second video camera (132) operatively connected to the remote station (124) for transmitting a video signal of one or more individuals at the remote station (124) to the set-top-box (102) for display on the television display (104).

12. A method for sportcare monitoring of a person, the method comprising:
operatively connecting a set-top-box (102) to at least one of a television display (104), a speaker (106), a first network (110), a remote station (124), and one or more wireless sensors (108);
measuring one or more vital signs of the person with the one or more wireless sensors (108);
wirelessly transmitting the one or more vital signs from the one or more wireless sensors (108) to the set-top-box (102);
operatively connecting the remote station (124) to the set-top-box (102) through the first network (110); and
transmitting the one or more vital signs from the set-top-box (102) to the remote station (124) via the fire network (110).

13. The method of claim 12, further comprising:
operatively connecting at least one sports equipment (128) to the set-top-box (102) via the remote station (124); and
transmitting performance characteristics from the at least one sports equipment (128) to the set-top-box (102).

14. The method of claim 13, further comprising storing the transmitted performance characteristics in a memory (116) operatively connected to the set-top-box (102).

15. The method of claim 13, further comprising transmitting the performance characteristics to the remote station (124) through the first network (110).

16. The method of claim 12, further comprising contacting a medical professional through a second network (114) from the set-top-box (102).

17. The method of claim 12, further comprising transmitting a video signal of the person to the remote station (124) from a first video camera (130) operatively connected to the set-top-box (102).

18. The method of claim 17, further comprising transmitting a video signal of one or more individuals at the remote station (124) from a second video camera (132) operatively connected to the remote station (124) to the set-top-box (102) for display on the television display (104).

19. The method of claim 12, further comprising coaching the person from the remote station (124) on at least one of the television display (104) and speaker (106) based at least in part on the transmitted at least one vital signs.

20. The method of claim 13, further comprising coaching the person from the remote station (124) on at least one of the television display (104) and speaker (106) based at least in part on the transmitted performance characteristics.

21. The method of claim 12, further comprising displaying at least one of a performance of another exercising person or a performance characteristic of the another person on the television display (104) such that the person can compete with the performance of the another person.

22. The method of claim 12, further comprising displaying a performance characteristic of the person on the television display (104).
